(19) United States
(12) Patent Application Publication
(10) Pub. No.: US 2008/0204776 A1
(43) Pub. Date: Aug. 28, 2008

(54) Printer and Control Method for the Same

(75) Inventor: Shunichi Wakasa, Nagano-ken (JP)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(73) Assignee: SEIKO EPSON CORPORATION, Tokyo (JP)

(21) Appl. No.: 12/030,279

(22) Filed: Feb. 13, 2008

(30) Foreign Application Priority Data
Feb. 27, 2007 (JP) 2007047583

(51) Int. Cl. G06F 15/00

(52) U.S. Cl. 358/1.9

(57) ABSTRACT

A printer that writes print data to the print buffer and runs the paper feed and printing process while receiving image data from a host computer desirably balances the speed of the paper feed and printing process and the speed of the conversion process to enable continuous printing so that white stripes do not appear in the printout. A print process run command and conversion format information specifying the conversion format for converting color block data in a print buffer 6 are temporarily stored. Based on the conversion format information stored in the receive buffer 4, whether the color block data can be transferred directly to the print buffer 6 and converted is determined (step S12). If direct transfer to the print buffer 6 is possible, the color block data sent after the conversion format information is directly transferred to the print buffer 6 without storing to the receive buffer 4, and the printing process is run according to the print process run command (step S16).

### CROSS-REFERENCE TO RELATED APPLICATIONS

Japanese Patent application No. 2007-047583 is hereby incorporated by reference in its entirety.

### BACKGROUND

1. Field of Invention

The present invention relates to a printer and to a printer control method for converting and writing graphic data that is sent from a host computer to a printer to the print buffer and executing the printing process while receiving the graphic data.

2. Description of Related Art

Printers that print both image data and character data generally always temporarily store print data received from a host computer to a receive buffer whether the received print data is image data or character data, and then sequentially read and convert the print data from the receive buffer to bitmap images, and write the bitmap images to the print buffer. This results in a time-consuming reception and conversion process when printing large image data files and thus lowers printing process speed.

Addressing this problem by focusing on the ability to immediately convert image data to the print buffer (referred to in the specification as an edit buffer) without first writing the data to the receive buffer if the image data is sent from the host computer as bitmapped data, Japanese Unexamined Patent Appl. Pub. JP-A-2000-108427 teaches a printer and a print data editing method for the printer that can quickly print print data containing image data by eliminating the step of temporarily storing the image data received from the host to a receive buffer.

Applying the print data editing method described in JP-A-2000-108427 to a thermal printer capable of printing plural colors is described next using by way of example a thermal printer that can print the two colors red and black. The image data for each color that is sent from the host computer is first written sequentially to the print buffer. The host computer alternately sends commands and print data, such as sending a command specifying the size of the red image data, then sending the red image data, then a command specifying the size of the black image data, and then sending the black image data. The red and black image data are written to the print buffer until a print command is received, and the print mechanism is driven and the printing process is executed.

However, the print data editing method taught in JP-A-2000-108427 requires storing the received data to a receive buffer and the CPU determining if the received data is a command specifying the data size or is the actual image data. This decision is repeated every time image data for a different color is received. The print command that follows the image data must also be temporarily stored to the receive buffer so that the CPU can determine if the received data was a print command.

FIG. 5 is a flow chart of a print data editing method according to the related art. FIG. 6 schematically describes communication between the host computer and printer, and FIG. 7 illustrates the actual printout.

When a command or print data sent from the host computer is received (step S51 returns Yes), the received command or image data is temporarily stored to the receive buffer (see FIG. 6(a)). The data stored in the receive buffer is sequentially read and interpreted by a command interpreter (step S52). If the command interpreter determines that a command for converting and writing image data of the first color, red in this example, to the print buffer was received, it determines if the red color data block corresponding to the color data block following the command can be passed to the print buffer by DMA transfer. If DMA transfer is possible, the image data is forwarded directly and written to the print buffer without first writing to the receive buffer (step S53 returns Yes, step S54, FIG. 6(b)).

Control then returns to step S51. DMA transfer stops because it is not known what type of data will be received next, and the data is received into the receive buffer instead of being transferred directly to the print buffer (FIG. 6(c)). If the command interpreter determines that a command for converting and writing image data of the second color, black in this example, to the print buffer was received (step S52, FIG. 6(d)), and the black image data for the color data block following the command (block A in FIG. 7) is data that can be stored by DMA transfer (step S53 returns Yes), the data is written to the print buffer by DMA transfer (step S54, FIG. 6(e)).

After writing the red and black image data to the print buffer, DMA transfer is interrupted, control returns to step S51, and the data sent from the host computer is received into the receive buffer (FIG. 6(f)). If the next received command is a print command (step S52, FIG. 6(g)), the print mechanism is driven based on the converted red and black image data and the printing process is executed for the corresponding block of color data (block A in FIG. 7) (step S56).

Repeating this process until the color data in block E in FIG. 7 is printed results in printout P.

The interpreting process of the command interpreter is considered next.

Whether the received command is a print command or is a command for storing red image data or black image data is determined three times, and whether the received image data is data that can be stored by DMA transfer is determined once each time a conversion command is received. Printing one color data block thus requires two determinations. Executing this operation for each of the five color data blocks A to E means that 25 command interpreting and evaluation operations are executed in the conversion process for printing image data P. Numerous command interpretations necessarily reduces conversion process speed, and thus lead to a drop in printing process speed.

The printing process speed varies greatly depending upon the balance between the conversion process speed when writing image data to the print buffer, and the printing speed at which the printing paper is conveyed and the thermal head or other printing mechanism is driven to print. If the balance between the printing speed and the conversion process speed is poor, the speed of the overall printing process drops.

More specifically, if the conversion process is too slow compared with the speed of the paper transportation and printing process, white bands a to d will appear between the color print data bands as shown in the sample printout in FIG. 7. These white bands a to d occur because the large number of command interpretations executed by the command interpreter slows the conversion process, causing an imbalance with the printing speed (including paper transportation and printing) and thus preventing continuous printing. In other words, because writing the next color data block to the print buffer has not ended by the time printing one color data block ends and printing the next color data block starts, the paper transportation process stops and the printer waits for data conversion to catch up before continuing the printing process. This tendency is particularly pronounced in a color thermal printer with a fast paper feed rate.

### SUMMARY OF INVENTION

A printer according to the present invention that writes to the print buffer and executes the printing and paper transportation process while receiving image data from a host computer enables printing continuously and eliminating unwanted white stripes in the printed output by desirably balancing the speed of the paper transportation and printing process with the speed of the conversion process.

A host computer according to a first aspect of the invention divides color data for a plurality of colors in the image data of an image into blocks of a prescribed data size, sends the color data blocks to a communicably connected image processing device, and controls a printing operation of the image processing device based on the color block data. The host computer sends to the image processing device a convert and print command that contains conversion format information specifying the conversion format used by an image conversion unit of the image processing device when converting the color block data, a print process run command, and color block data for the plural colors.

This aspect of the invention combines the conversion format information, a print process run command, and the image data segments (blocks) into a single convert and print command. The image processing device that receives this convert and print command can therefore convert the color block data in an image conversion unit and print the converted color block data by reading and interpreting a single convert and print command.

Another aspect of the invention is an image processing device that receives color data blocks segmenting color data for a plurality of colors in the image data for an image into blocks of a prescribed data size from a host computer, converts the color data blocks in an image conversion unit, and runs a printing process based on the converted color data blocks. The image processing device has a receive buffer that temporarily stores conversion format information specifying the conversion format for converting the color block data in the image conversion unit; a data interpreting unit that determines if the color block data can be transferred directly to the image conversion unit and converted based on the conversion format information stored in the receive buffer; and a print processing unit that directly transfers and converts the color block data transmitted following the conversion format information to the image conversion unit without going through the receive buffer when the data interpreting unit determines the color block data can be transferred directly, and runs the printing process according to the print process run command.

Another aspect of the invention is a control method for an image processing device that receives color data blocks segmenting color data for a plurality of colors in the image data for an image into blocks of a prescribed data size from a host computer, converts the color data blocks in an image conversion unit, and runs a printing process based on the converted color data blocks. The control method has steps of: temporarily storing conversion format information specifying the conversion format for converting the color block data in the image conversion unit; determining if the color block data can be transferred directly to the image conversion unit and converted based on the conversion format information stored in the receive buffer; and directly transferring and converting the color block data transmitted following the conversion format information to the image conversion unit without going through the receive buffer when it is determined that the color block data can be transferred directly, and running the printing process according to the print process run command.

The invention thus determines if color block data for a plurality of colors can be directly transferred to the image conversion unit based on the conversion format information contained in a single convert and print command, and transfers the image data directly to the image conversion unit without first buffering the data to the receive buffer if direct transfer is determined possible. Compared with sending the color block data separately for each color, first receiving the data into the receive buffer each time a command and color block data are received, interpreting the command, and then converting the data in the image conversion unit as in the related art, the method of the invention reduces the number of times commands are interpreted, and can complete the DMA transfer once it starts without interruption between the color data blocks. The conversion process to the image conversion unit can therefore be accelerated, the speed of the paper feed and printing process and the speed of the conversion process can be balanced more desirably than in the related art, and printing can run continuously. A clean printout free of white stripes between image blocks can thus be achieved.

The present invention also relates to a printing process system that has a host computer and an image processing device.

This printing process system desirably balances desirably balances the speed of the paper feed and printing process and the speed of the conversion process to enable continuous printing so that white stripes do not appear in the printout.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a control block diagram showing the main control parts of a thermal printer according to a preferred embodiment of the invention.

FIGS. 2A and 2B are schematic diagrams showing an example of the image data described in this embodiment of the invention.

FIG. 3 is a flow chart showing the convert and print process executed by the thermal printer 1 of this embodiment.

FIGS. 4A-4D schematically show communication between the host computer and the printer in this embodiment of the invention.

FIG. 5 is a flow chart of a print data editing method according to the related art.

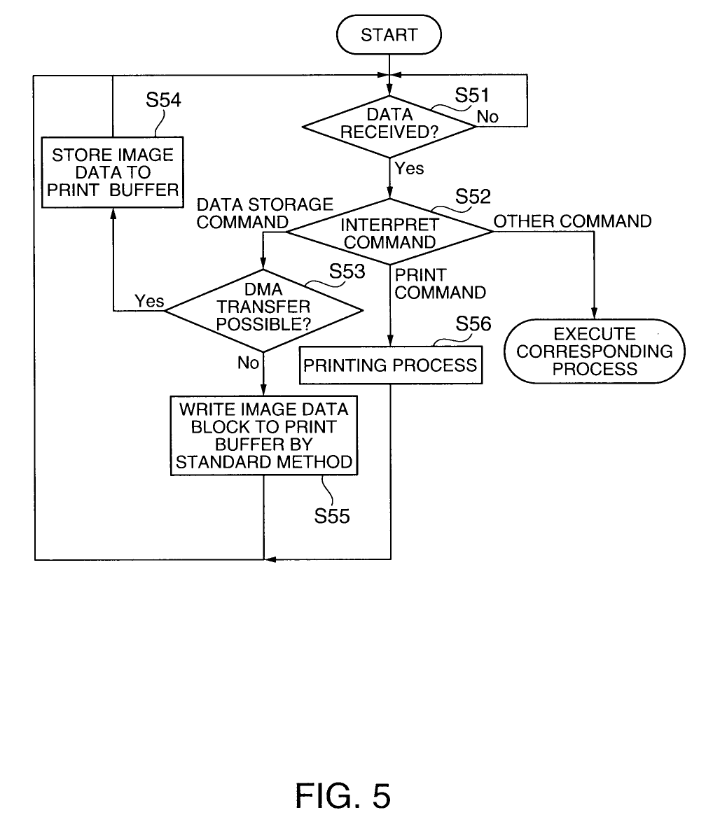

FIGS. 6A-6G schematically shows communication between the host computer and printer according to the related art.

FIG. 7 shows an example of the actual printout obtained by the print data editing method according to the related art.

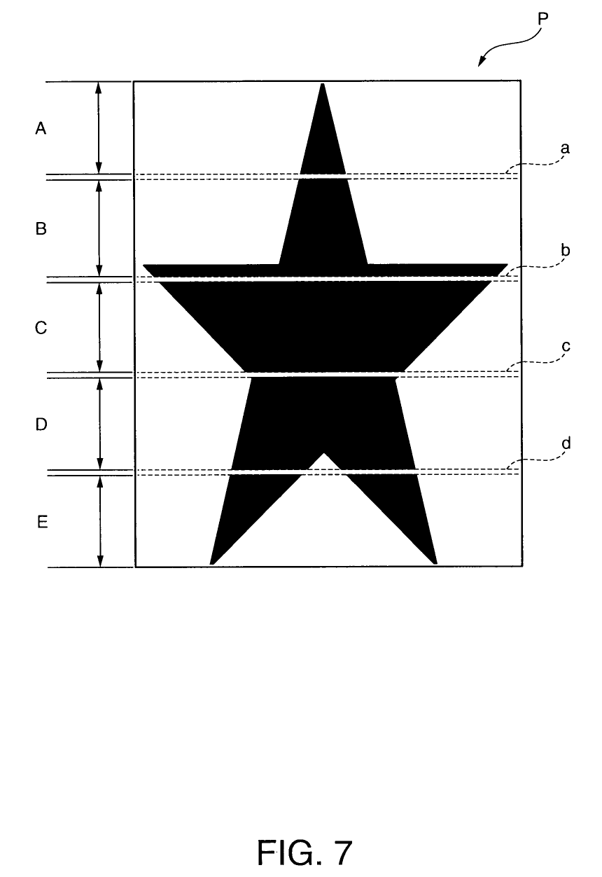

### DESCRIPTION OF THE PREFERRED EMBODIMENTS

A preferred embodiment of an image processing device according to the present invention is described below with reference to the accompanying figures using a thermal printer by way of example. This embodiment of the invention uses by way of example a thermal printer that is communicably connected to a host computer for printing and is suitable for use in a POS system, for example.

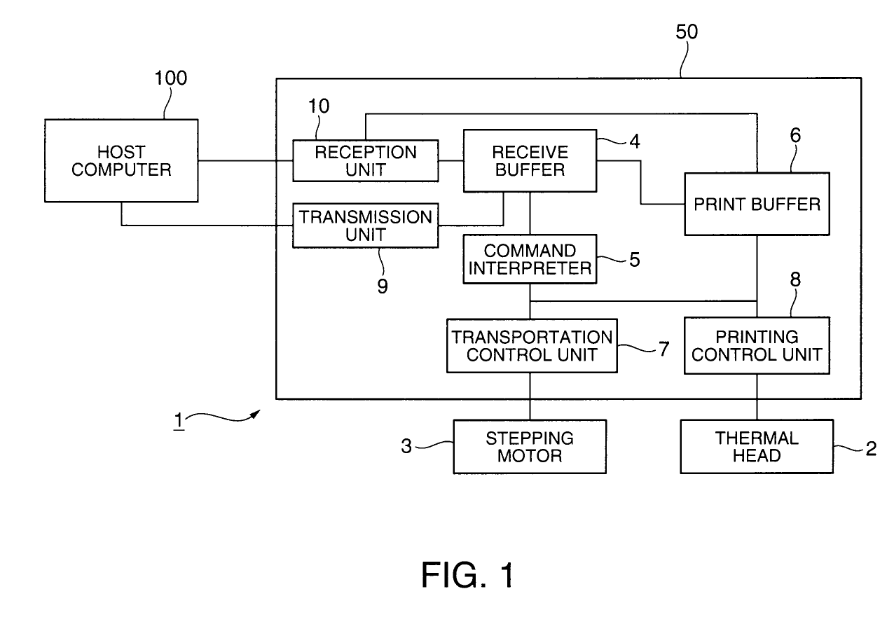

FIG. 1 is a control block diagram showing the main control parts of a thermal printer 1 according to this embodiment of the invention. The thermal printer 1 has a thermal head 2, a stepping motor 3, and a printer control device 50 that controls driving the thermal head 2 and the stepping motor 3. The stepping motor 3 drives a platen roller that conveys the printing paper passed the printing position of the thermal head 2.

The printer control device 50 has a reception unit 10, a receive buffer 4, a command interpreter 5, a print buffer 6 (image conversion unit), a transportation control unit 7, and a printing control unit 8. Commands and print data are supplied to the printer control device 50 from host computer 100 through the reception unit 10. The transportation control unit 7 controls driving the stepping motor 3 and the printing control unit 8 controls driving the thermal head 2 according to the received commands and image data.

Color data blocks that are segments of the color image data in one picture are sent from the host computer 100 to the printer control device 50. The received color data blocks are converted and written to the print buffer 6, and the printing process is run based on the converted color data blocks. More specifically, if the printer is a thermal printer that can print two colors, red and black, red color data blocks and black color data blocks from the host computer 100 are each written to respective print buffers 6. The size of the transmitted color data blocks is determined by the storage capacity of the print buffer 6.

The reception unit 10 is an interface for receiving image data, for example. Commands and data received through the reception unit 10 are temporarily stored in the receive buffer 4. Before the color data blocks for the two colors, red and black, are sent, conversion format control information, which includes the number of colors in the color data blocks and the color information for the color data blocks, and a printing process run command are sent, and this data is stored temporarily.

The command interpreter 5 sequentially reads and interprets the data temporarily stored in the receive buffer 4. Based on the result of interpreting the read data, the command interpreter 5 determines whether the image data can be transferred directly to the print buffer 6 without writing first to the receive buffer 4, that is, if DMA transfer is possible.

The print buffer 6 is the memory area where the color data blocks of each color received through the reception unit 10 are converted. If the command interpreter 5 determines that the received color data block can be written directly to the print buffer 6 without going through the receive buffer 4, the color data is written directly from the reception unit 10 to the print buffer 6 by DMA transfer.

The transportation control unit 7 advances the printing paper a prescribed distance determined by the print process run command, which is contained in the convert and print command that is sent together with the conversion format information and the color block data, that is, the actual data to be printed.

The printing control unit 8 drives the thermal head 2 to print the red and black two-color image block according to the print process run command contained in the convert and print command based on the converted color block data.

### Convert and Print Process

The convert and print process applied to the image data by the thermal printer 1 according to this embodiment of the invention is described next with reference to the accompanying figures.

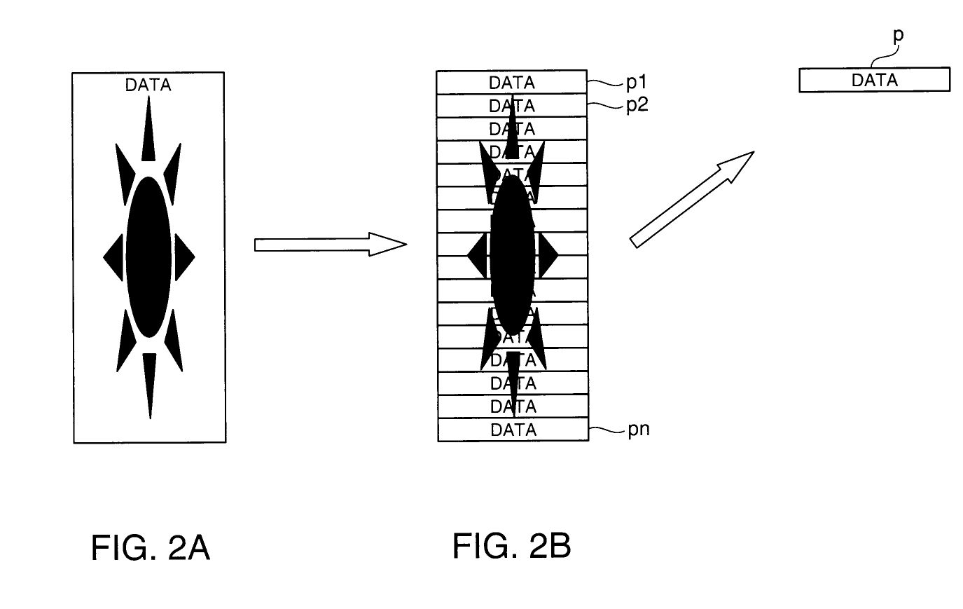

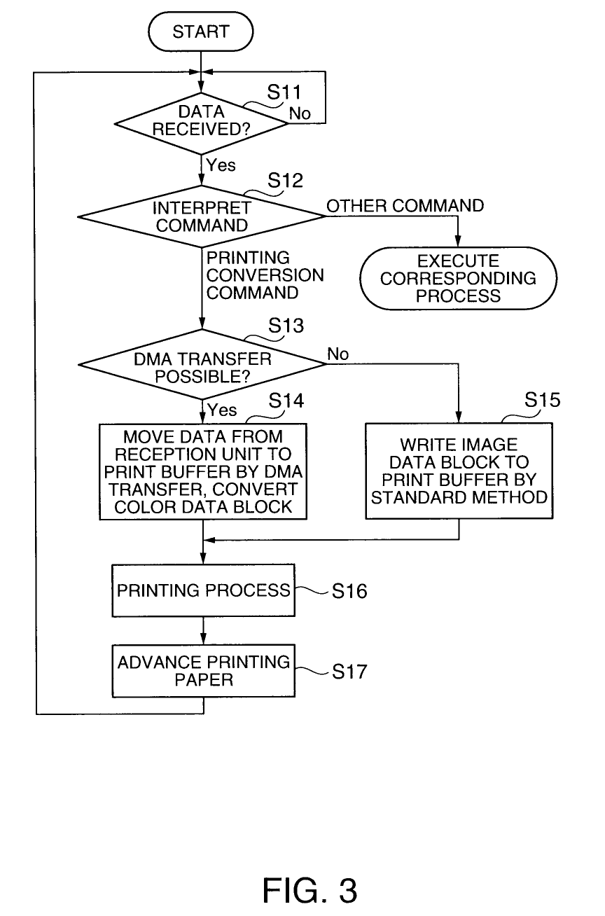

FIG. 2 is a schematic diagram showing an example of the image data described in this embodiment of the invention, and FIG. 3 is a flow chart describing the convert and print process executed by the thermal printer 1 of this embodiment.

The host computer 100 has a printer driver that controls the overall operation of the thermal printer 1, and the image data P created by an application on the host computer 100 (FIG. 2(a)) is rasterized by the printer driver. The image data P is composed of color data for multiple colors, and in this embodiment of the invention is composed of color data for the two colors red and black.

The printer driver of the host computer 100 rasterizes the image data and divides the rasterized image data into plural blocks as shown in FIG. 2(b). The thermal printer 1 receives the segmented color data blocks p one at a time. The size of each color data block p is at least a size that can be converted and written to the print buffer 6, and in this embodiment of the invention one image P is segmented into 16 color data blocks p1 to pn that are received through the reception unit 10.

The printer driver generates a convert and print command for writing the image data P to the print buffer 6 of the thermal printer 1 and running the printing process. As described above this convert and print command includes at least the color data in image data P, the number of colors, a print start command, and the color block data that is the actual image data. An example of the parameters of the convert and print command is shown below.

m fn a b [c nL nH xL xH yL yH]1 . . . [c nL nH xL xH yL yH]b [d1 . . . dk]1 . . . [d1 . . . dk]b

These parameters of the convert and print command are described below.

m specifies a constant value enabling the function

a specifies a constant value enabling the function

b declares the number of colors in the rasterized color block data

c declares the color of the declared data

nL, nH specify the amount of movement

xL, xH declare the number of dots on the horizontal axis of the rasterized image data

yL, yH declare the number of dots on the vertical axis of the rasterized image data

d indicates the declared data

k is a descriptive parameter indicating the image data count and is not transmitted data.

The convert and print process is described next referring to FIG. 3.

The printer driver of the host computer 100 generates and sends a convert and print command to the thermal printer 1. When the thermal printer 1 receives the convert and print command through the reception unit 10 (step S11 returns Yes), the parameter string described above is stored sequentially to the receive buffer 4. The format parameters (m fn a b [c nL nH xL xH yL yH]1 . . .[c nL nH xL xH yL yH]b) including the conversion format information and the print process run command for the actual data ([d1 . . . dk]1 . . . [d1 . . . dk]b) are extracted from the convert and print command and stored in the receive buffer 4. If the receive buffer 4 becomes full while temporarily storing the received data, a busy signal is sent through the transmission unit 9 to the host computer 100 to pause command transmission from the host computer 100.

The command interpreter 5 sequentially reads the format parameters stored in the receive buffer 4 and starts command interpreting (step S12). The conversion format of the following image data [d1 . . . dk]1 . . . [d1 . . . dk]b is determined based on the format parameters m fn a b [c nL nH xL xH yL yH]1 . . . [c nL nH xL xH yL yH]b. For example, the command interpreter 5 knows the number of colors in the following color block data by reading parameter b, and knows that color block data for the plural number of colors will be received. The color information for the color data blocks is also known by reading parameter c. In this example the command interpreter 5 knows by reading parameter c that the following color data blocks contain color data for the two colors red and black.

If the result of command interpretation in step S12 is that the received command is a command other than the convert and print command, the process corresponding to the received command is run.

Whether the following actual image data can be written to the print buffer 6 by DMA transfer is then determined from the format parameters (step S13). If DMA transfer is possible, the image data [d1 . . . dk]1 . . . [d1 . . . dk]b is written directly to the print buffer 6 without going through the receive buffer 4 (step S14). If DMA transfer is not possible, the image data is first buffered to the receive buffer 4 and then converted to the print buffer 6 using a standard data transfer method (step S15).

While DMA transfer can be used unconditionally without determining if DMA transfer is possible, the condition used in this embodiment to determine if DMA transfer is possible is whether DMA transfer will accelerate the conversion process. For example, if the result of command interpretation in step S12 is that the parameters specify equal height and width and the printing start position is evenly divisible by 8, the printing process can proceed immediately after DMA transfer without requiring a separate process to stretch the converted color block data horizontally or vertically. DMA transfer therefore has the effect of accelerating the conversion process.

When data conversion for color data block p1 ends, the printing control unit 8 drives the thermal head 2 to run the printing process (step S16), color data block p1 is printed to the paper, and the transportation control unit 7 drives the stepping motor to advance the paper a prescribed distance (step S17). If a convert and print command is then received from the host computer 100 for the color data block p2, steps S11 to S17 repeat. This continues until the last image block is processed to get the printed image P.

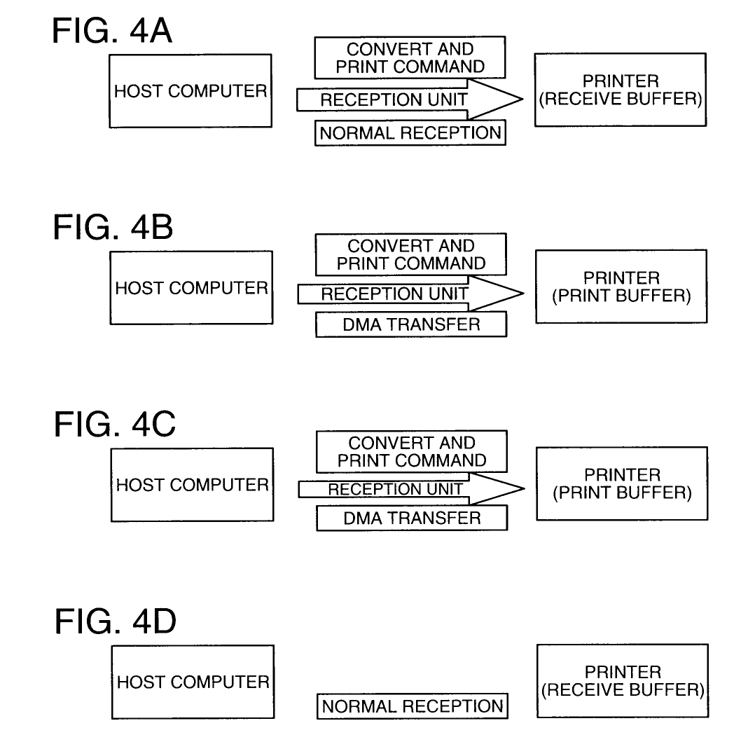

The process described above is compared with the process run by a conventional thermal printer. FIG. 4 schematically describes communication between the host computer and the printer.

A single convert and print command according to this embodiment of the invention includes conversion format information containing the number of colors in the color block data, the colors in the color block data, and a print process run command, and the actual color block data. The command interpreter 5 therefore only needs to interpret the conversion format information contained in one convert and print command once in order to write the color data block p1 to the print buffer 6.

In other words, a convert and print command received normally through the reception unit 10 as shown in FIG. 4(a) is first stored to the receive buffer 4. If the command interpreter 5 determines that DMA transfer of the actual print data to the print buffer 6 is possible based on the information contained in the convert and print command, the color block data for the first color received through the reception unit 10 is written directly to the print buffer 6 as shown in FIG. 4(b). As shown in FIG. 4(c), the color block data for the second color that is received next is sent directly to the print buffer 6 and converted.

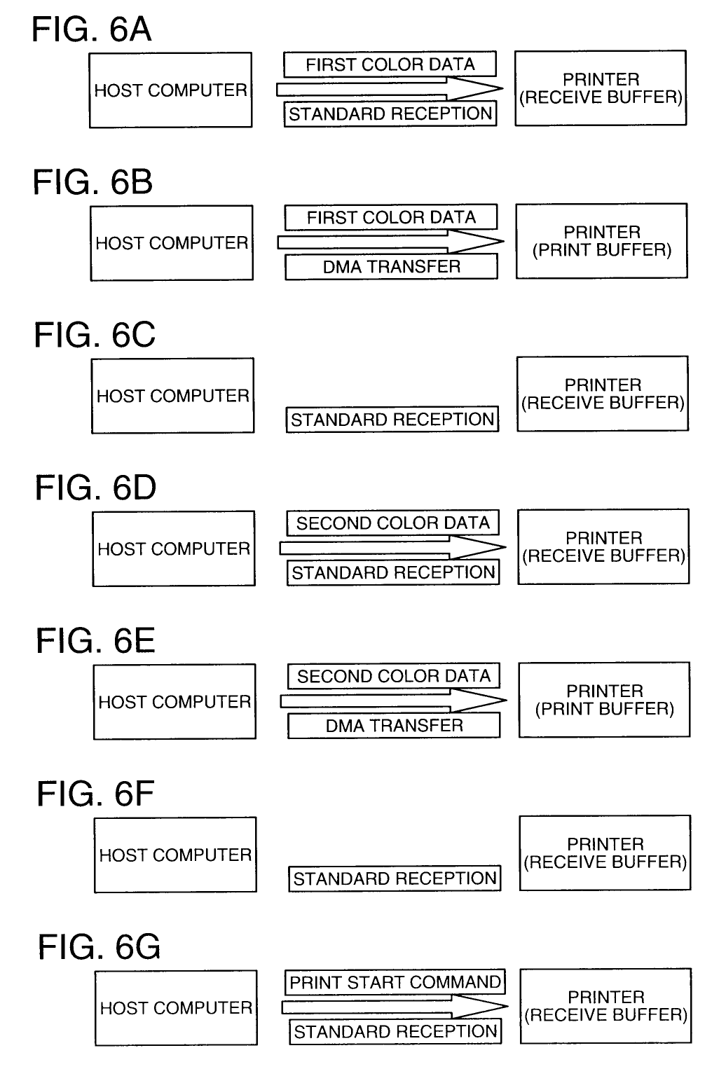

Conventionally, however, DMA transfer is interrupted and the destination for the color block data must be reset from the print buffer to the receive buffer so that data is received into the receive buffer between the conversion process for the color block data for the first color and the conversion process for the color block data for the second color (FIG. 6(c)), and between the conversion process for color block data for the second color and receiving the print command (FIG. 6(f)).

The method of the present invention, however, enables the conversion process to continue smoothly without interrupting DMA transfer between the conversion process for the color block data for the first color and the conversion process for the color block data for the second color.

The invention thus accelerates the conversion process compared with the related art and maintains a good balance between the speed of the paper feed and printing process and the speed of the conversion process in a thermal printer that writes image data to the print buffer 6 and prints while receiving image data from a host computer 100, and thus enables printing continuously. Because the printer can print continuously, the invention can also prevent creating white stripes between color data blocks as a result of the printing process being interrupted.

The thermal printer 1 in this embodiment of the invention is described as having color selection information registered for two colors, red and black, but the invention is obviously not so limited and the invention can also be used with more than two printable colors. The image data conversion process can thus be accelerated even more by DMA transfer in this case because color block data for more than two colors is merged in a single convert and print command sent to the thermal printer.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. A host computer that divides color data for a plurality of colors in the image data for an image into blocks of a prescribed data size, sends the color data blocks to a communicably connected image processing device, and controls a printing operation of the image processing device based on the color block data, wherein:
the host computer sends to the image processing device a convert and print command that contains conversion format information specifying the conversion format used by an image conversion unit of the image processing device when converting the color block data,
a print process run command, and
color block data for the plural colors.

2. An image processing device that receives color data blocks segmenting color data for a plurality of colors in the image data for an image into blocks of a prescribed data size from a host computer, converts the color data blocks in an image conversion unit, and runs a printing process based on the converted color data blocks, comprising:
a receive buffer that temporarily stores conversion format information specifying the conversion format for converting the color block data in the image conversion unit;
a data interpreting unit that determines if the color block data can be transferred directly to the image conversion unit and converted based on the conversion format information stored in the receive buffer; and
a print processing unit that directly transfers and converts the color block data transmitted following the conversion format information to the image conversion unit without going through the receive buffer when the data interpreting unit determines the color block data can be transferred directly, and runs the printing process according to the print process run command.

3. A control method for an image processing device that receives color data blocks segmenting color data for a plurality of colors in the image data for an image into blocks of a prescribed data size from a host computer, converts the color data blocks in an image conversion unit, and runs a printing process based on the converted color data blocks, comprising steps of:
temporarily storing conversion format information specifying the conversion format for converting the color block data in the image conversion unit;
determining if the color block data can be transferred directly to the image conversion unit and converted based on the conversion format information stored in the receive buffer; and
directly transferring and converting the color block data transmitted following the conversion format information to the image conversion unit without going through the receive buffer when it is determined that the color block data can be transferred directly, and running the printing process according to the print process run command.
